(19) United States
(12) Patent Application Publication
(10) Pub. No.: US 2019/0221900 A1
(43) Pub. Date: Jul. 18, 2019

(54) HIGH POWER BATTERY/CAPACITOR MODULE

(71) Applicant: BGT MATERIALS LIMITED, Manchester (GB)

(72) Inventors: Hsiao-Hsuan SHEN, Kaohsiung (TW); Kuo-Hsin CHANG, Chiayi (TW); Chung-Ping LAI, Hsinchu County (TW)

(21) Appl. No.: 15/872,205

(22) Filed: Jan. 16, 2018

(51) Int. Cl. H01M 10/613; H01M 10/6556; H01M 10/46; H01M 10/42; H02J 7/00; H01G 9/145

(52) U.S. Cl. CPC H01M 10/613; H01M 10/6556; H01M 10/46; H02J 7/345; H02J 7/0052; H01G 9/145; H01M 2220/20; H01M 10/4214

(57) ABSTRACT

A high power battery/capacitor module is revealed. The high power battery/capacitor module includes a box, electrolyte solution, cells and a heat exchanging device. A chamber in the box is connected to the heat exchanging device to form a closed fluid circulation space. The electrolyte solution is filled into the chamber and the cells are arranged at the chamber of the box. The cells are immersed into and electrically insulated from the electrolyte solution. The electrolyte solution is cooled down by the heat exchanging device after being drawn away from the chamber and then delivered back to the chamber circularly. The high power battery/capacitor module further includes an automatic device for detecting and balancing concentrations of ions in the electrolyte solution. Thus the present battery/capacitor module solves the problems caused by heat generated during charging/discharging and extends service life of the battery/capacitor system by using electrolyte solution as coolant.

### BACKGROUND OF THE INVENTION

### Field of the Invention

The present invention relates to a battery/capacitor module, especially to a high power battery/capacitor module using electrolyte solution as coolant and involved in temperature control of secondary batteries.

### Description of Related Art

In order to eliminate pollution (such as air pollution) caused by fossil fuel vehicles that use petrol or diesel, the trends of electric vehicles (EV), hybrid electric vehicles (HEV), and Plug-in HEV in near future are inevitable. Generally, a power battery used in vehicles includes a plurality of battery cells. The most common battery cell used is lithium ion battery (LIB). A plurality of packed cells is connected in series/parallel and then packed into a battery module/battery pack. The number of the battery modules/battery packs used depends on the power the vehicle requires. These battery modules/battery packs include thousands of battery cells.

One of the inevitable technical problems of the electric vehicles is heat generated during charge/discharge cycles of the power battery. The temperature is a key factor that affects service life and safety of the power battery. The battery overheating accelerates side reactions inside the battery and shortens the service life. In the worst case, the battery starts a thermal runaway that causes safety problems such as fire or explosions. The optimal operating temperature of the lithium ion battery is ranging from 25 degrees Celsius (° C.) to 40° C. Thus thermal management of the power battery has become one of the key research topics.

A high power battery and/or capacitor system is required by many applications such as electric vehicles. There is no other way to solve the problems associated with heat now except using cooling medium such as air, liquid or solid around the packed battery and/or capacitor unit.

The temperature control of lithium ion batteries can be achieved by various ways including air-cooling, fluid-cooling and PCM (phase change material)-cooling. Refer to US pat. App. No. 20110059347, a battery module with an air cooling type heat exchange member is revealed. A plurality of heat dissipation members is disposed in two or more interfaces between respective plate-shaped battery cells. Air passed through the heat dissipation members is used as coolant. Refer to Chinese Pat. Pub. No. CN202076386U, a battery temperature management system revealed. The battery temperature management system includes a battery pack, a heat exchanging system and a temperature control device. The heat exchanging system consists of a heat exchanger, a cooling liquid circulating pipeline, and refrigerant circulating pipeline. The battery is heated or cooled by heat exchange in the system and the medium used is cooling liquid, instead of air. Refer to US Pat. App. No. 20100279154, battery systems, battery modules and method for cooling a battery module are revealed. A phase change material is used as a coolant for heat dissipation of the battery. Basically the coolant or the refrigerant is the same as that used in the cooling system of the compressor and the condenser such as ethylene glycol (coolant), or R-11 and R-134A (refrigerants).

The above prior arts use cooling modules built outside the battery/capacitor module. These prior arts either improve the cooling modules around the battery/capacitor module or focus on the use of different materials for cooling plates or heat dissipation parts outside the battery/capacitor module. The battery/capacitor module and the cooling system are separated from each other in these patents and the cooling system of the battery doesn't work effectively. The lithium ion battery is composed of an anode (such as graphite), a cathode (such as lithium), electrolyte, and a separator. Most of the electrolyte in the battery is in the liquid form, also called electrolyte solution. In order to prevent oxidation and moisture, the electrode, the electrolyte, and the separator required are mounted in a permanently-sealed pack. The problem lies in that the packing material reduces thermal conduction and there is no direct heat transfer between the electrolyte solution and the air outside. All of the above patents have tried to reduce temperature outside the battery module/battery pack.

Thus there is room for improvement and there is a need to provide a novel battery/capacitor module.

### SUMMARY OF THE INVENTION

Therefore it is a primary object of the present invention to provide a high power battery/capacitor module that solves the problems caused by heat generated during charging/discharging process of the high-power battery/capacitor module.

In order to achieve the above object, a high power battery/capacitor module according to the present invention includes a box, electrolyte solution, unpacked cells and a heat exchanging device. The box can be a rigid container or a flexible container. The box consists of a chamber therein, an inlet and an outlet, both communicated with the chamber. The electrolyte solution is filled in the chamber while the unpacked cells are arranged at the chamber and are immersed in the electrolyte solution. A first electrode set outside the box is electrically connected to positive electrodes of the cells and a second electrode disposed outside the box is electrically connected to negative electrodes of the cells. The heat exchanging device is connected to both the inlet and outlet of the box. A closed fluid circulation space is formed by the heat exchanging device in combination with the chamber. The electrolyte solution drawn from the chamber through the outlet is passed through the heat exchanging device to be cooled down and then delivered back to the chamber through the inlet circularly. Thus the unpacked cells are cooled inside by using the electrolyte solution as coolant. Therefore the present high power battery/capacitor module can be used without suffering problems caused by heat generated during charging/discharging.

The high power battery/capacitor module according to the present invention further includes an automatic device for balancing concentrations of ions which detects charge carrier/ion concentration in the chamber. The same electrolyte solution at higher concentrations is filled into the chamber or the heat exchanger automatically once the detection result shows that the ion concentration is lower. Thus the ion concentration around the electrodes of the unpacked cells remains stable. The degradation of cell capacity and shorter cell cycle caused by reduced lithium ions can be minimized. The service life of the battery/capacitor module is further extended.

The high power battery/capacitor module of the present invention further includes a charger that is electrically connected to an external power source, the first electrode and the second electrode. The cells are charged by the charger using power from the external power source.

The heat exchanging device is composed of a heat exchanger and a pump that are connected to the inlet and the outlet of the box respectively by pipelines. The electrolyte solution is drawn from the chamber through the outlet to be passed through the heat exchanger for temperature reduction and then is returned to the chamber through the inlet circularly by the pump.

The heat exchanging device is disposed on a charging pile that includes a charging plug. A first fluid connector and a second fluid connector are set on the charging plug. The first fluid connector and the second fluid connector are connected to the inlet and the outlet of the box respectively. A heat transfer medium inlet and a heat transfer medium inlet outlet on the heat exchanger of the heat exchanging device are connected to the first fluid connector and the second fluid connector of the charging plug respectively.

It is another object of the present invention to provide a high power battery/capacitor module for vehicles and a charger thereof.

In order to achieve the above object, a high power battery/capacitor module for vehicles and a charger thereof according to the present invention includes a box, electrolyte solution, unpacked cells, a heat exchanging device and a charger. The box can be a rigid container or a flexible container. The box not only has a chamber therein but also includes an inlet and an outlet that are communicated with the chamber. The chamber is filled with the electrolyte solution while the unpacked cells are mounted in the chamber of the box and are immersed into the electrolyte solution. A first electrode disposed outside the box is electrically connected to positive electrodes of the cells and a second electrode set outside the box is electrically connected to negative electrodes of the cells. The heat exchanging device is connected to both the inlet and outlet of the box and working together with the chamber to form a closed fluid circulation space. The electrolyte solution drawn from the chamber through the outlet is passed through the heat exchanging device to be cooled down and then delivered back to the chamber through the inlet in a circular manner. The charger is electrically connected to an external power source, the first electrode and the second electrode. The cells are charged by the charger using power from the external power source.

The heat exchanger is disposed on a front side of the vehicle for reducing temperature of the electrolyte solution by air-cooling or water-cooling solution. Then the cooled electrolyte solution is delivered back to the chamber through the inlet of the box.

The heat exchanging device is disposed on a charging pile that includes a charging plug. A first fluid connector and a second fluid connector are set on the charging plug. The first fluid connector and the second fluid connector are connected to the inlet and the outlet of the box respectively. A heat transfer medium inlet and a heat transfer medium inlet outlet on the heat exchanger of the heat exchanging device are connected to the first fluid connector and the second fluid connector of the charging plug. Thereby problems caused by heat generated during charging/discharging process of the high power battery/capacitor module can be solved when the vehicle hooks up to the charging pile and gets charged.

The high power battery/capacitor module for vehicles and a charger thereof according to the present invention further includes an automatic device for balancing concentrations of ions that detects charge carrier/ion concentration in the chamber. The same electrolyte solution at higher concentrations is filled into the chamber or the heat exchanger automatically once the detection result shows that the ion concentration is lower.

The automatic device for balancing concentrations of ions of the present invention is composed of a detector used for detecting ion concentration of the electrolyte solution in the chamber, a first container for storage of electrolyte solution with high concentration of ions, a second container in which electrolyte solution with low concentration of ions is stored, a distributor that is connected to the first container, the second container and the chamber, and the control circuit electrically connected to the detector and the distributor. The electrolyte solution with high concentration of ions in the first container and the electrolyte solution having low concentrations of ions in the second container can be optionally delivered and filled into the chamber by the distributor. According to detection results of the detector, the electrolyte solution with high concentration of ions in the first container or the electrolyte solution with low concentration of ions in the second container is delivered and filled into the chamber by the distributor under control of the control circuit.

The charger is arranged at the charging pile and is electrically connected to mains electricity that is used as an external power source.

The charger is set on the vehicle and electrically connected to an alternator of the vehicle. Thus the charger can use power from the alternator that works as an external power source.

The present invention features on that the electrolyte solution is used as coolant in the high power battery/capacitor module. The unpacked cells (composed of a cathode/a separator/an anode) are mounted in the chamber of the box and the electrolyte solution used as coolant is delivered into and out of the chamber by sealed hoses/tubes. During charging and discharging cycles, heat generated by the cells is sent to the heat exchanger outside together with the electrolyte solution for dissipation. Thus problems caused by heat generated upon charging and discharging operations of the high power battery/capacitor module can be solved and the service life of the battery/capacitor system is prolonged. Moreover, the automatic device for balancing concentrations of ions makes the concentration of ions around the electrodes of the unpacked cells stable. The degradation of cell capacity and shorter cell cycle caused by reduced lithium ions can be minimized. The service life of the battery/capacitor module is also extended.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic drawing showing structure of an embodiment according to the present invention;

FIG. 2 is a schematic drawing showing structure of another embodiment according to the present invention;

FIG. 3 is a schematic drawing showing structure of a further embodiment according to the present invention;

FIG. 4 is a partial view of an embodiment showing a box according to the present invention;

FIG. 5 is a partial view of an embodiment showing a charger according to the present invention;

FIG. 6 is a partial view of an embodiment showing a heat exchanger being disposed on a vehicle for heat dissipation according to the present invention.

### DETAILED DESCRIPTION OF THE PREFERRED EMBODIMENT

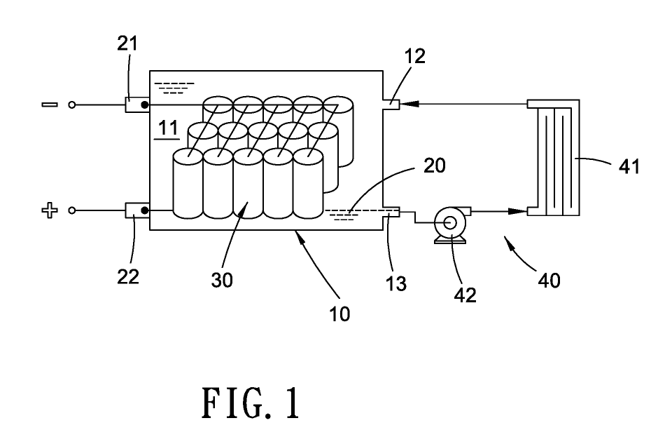

Refer to FIG. 1 a high power battery/capacitor module according to the present invention includes a box 10, electrolyte solution 20, a plurality of unpacked cells 30 and a heat exchanging device 40.

The box 10 is composed of a chamber 11 therein, an inlet 12 and an outlet 13. The inlet 12 and the outlet 13 are communicated with the chamber 11. The box 10 can be a rigid container or a flexible container.

The electrolyte solution 20 is filled into the chamber 11 through the inlet 12 and is drained from the chamber 11 through the outlet 13.

The unpacked cells 30 (each of which is generally composed of a cathode, a separator and an anode) are connected in series and/or in parallel and mounted in the chamber 11 of the box 10. The cells 30 are immersed into the electrolyte solution 20 while positive electrodes of the cells 30 are electrically connected to a first electrode 21 outside the box 10 and negative electrodes of the cells 30 are electrically connected to a second electrode 22 outside the box 10.

The heat exchanging device 40 is connected to both the inlet 12 and outlet 13 of the box 10. A closed fluid circulation space is formed by the heat exchanging device 40 together with the chamber 11. The electrolyte solution 20 in the chamber 11 is carried out through the outlet 13, passed through the heat exchanging device 40 to be cooled down, and then delivered back to the chamber 11 through the inlet 12 circularly.

The heat exchanging device 40 consists of a heat exchanger 41 and a pump 42 that are connected to the inlet 12 and the outlet 13 of the box 10 respectively by pipelines. Heat generated during charging/discharging of the cells 30 is absorbed by the electrolyte solution 20. The electrolyte solution 20 with the heat absorbed is drawn from the chamber 11 through the outlet 13, passed through the heat exchanger 41 for temperature reduction, and then the cooled electrolyte solution 20 is sent back to the chamber 11 through the inlet 12 by the pump 42 in a circular manner. The electrolyte solution 20 used as coolant can also be introduced into and removed from the chamber 11 by sealed hoses/tubes. During charging and discharging, heat generated by the cells 30 is delivered to the heat exchanger 41 located outside the chamber 11 together with the electrolyte solution 20. Thus the problems caused by heat occurred upon charging and discharging operations of the high power battery/capacitor module can be solved and the service life of the battery/capacitor system is extended.

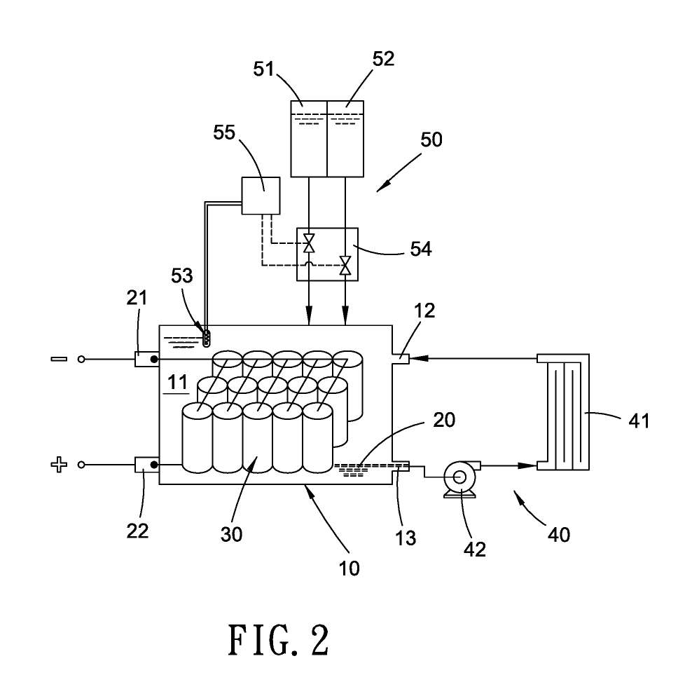

Refer to FIG. 2, another embodiment of a high power battery/capacitor module of the present invention further includes an automatic device for balancing concentrations of ions 50 that detects the concentrations of ions in the electrolyte solution 20. Once the detection result shows that the ion concentration is lower, the same electrolyte solution 20 at higher concentrations is filled into the chamber 11 or the heat exchanger 41 automatically. Thus the concentration of ions around the electrodes of the cells 30 remains stable. The degradation of cell capacity and shorter cell cycle caused by reduced lithium ions can be minimized. The service life of the battery/capacitor module is also prolonged. The automatic device for balancing concentrations of ions 50 consists of a first container 51 used for storage of electrolyte solution with high concentration of ions, a second container 52 in which electrolyte solution with low concentration of ions is stored, a detector 53 that detects ion concentration of the electrolyte solution 20, a distributor 54, and a control circuit 55. The distributor 54 is connected to the first container 51, the second container 52 and the chamber 11/or the heat exchanger 41. The electrolyte solution with high concentration of ions in the first container 51 and the electrolyte solution having low concentrations of ions in the second container 52 can be optionally delivered and filled into the electrolyte solution 20 by the distributor 54. The control circuit 55 is electrically connected to the detector 53 and the distributor 54. According to detection results of the detector 53, the electrolyte solution with high concentration of ions in the first container 51 or the electrolyte solution with low concentration of ions in the second container 52 is delivered and filled into the electrolyte solution 20 by the distributor 54 under control of the control circuit 55. For example, replenishment, balance and regulation of ions in the electrolyte solution 20 can be done through the heat exchanger 41 or the chamber 11 connected to the distributor 54 by pipelines.

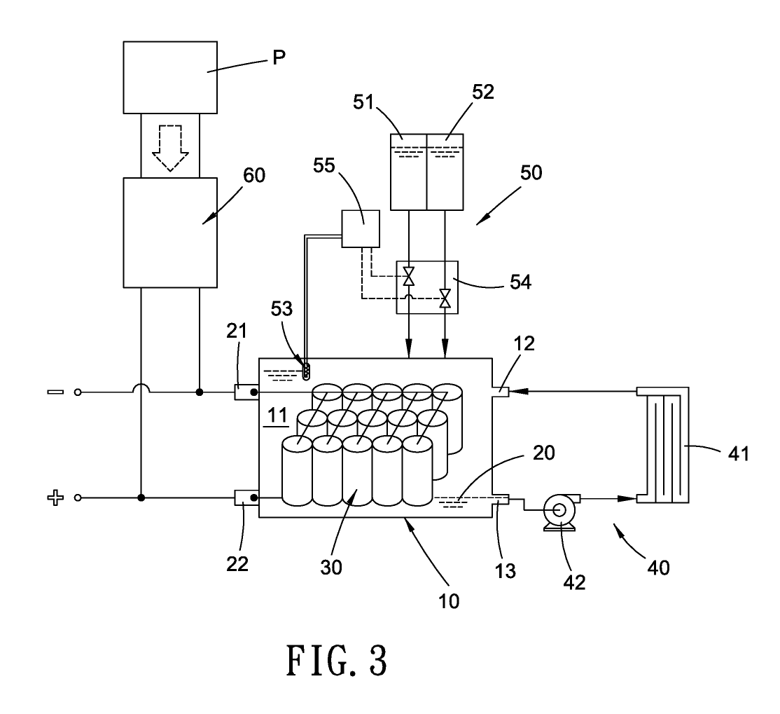

Refer to FIG. 3, a further embodiment of a high power battery/capacitor module according to the present invention further includes a charger 60 that is electrically connected to an external power source P, the first electrode 21 and the second electrode 22. The cells 30 are charged by the charger 60 using power from the external power source.

A high power battery module of the present invention can be applied to vehicles. In an embodiment of the present invention, a plurality of cells 30 is mounted into a chamber 11. After the cells 30 being connected in series and/or in parallel, positive electrodes of the cells 30 are electrically connected to a first electrode 21 and negative electrodes of the cells 30 are electrically connected to a second electrode 22 so as to form a battery module (also called battery pack). In general, a vehicle may need a plurality of battery modules/battery packs. Inlets 12 and outlets 13 of these battery modules/battery packs are connected to the heat exchanging device 40 by pipelines to form a closed fluid circulation space. Thus the cells 30 can be cooled down.

Moreover, the cell 30 in the embodiment of the present invention can be replaced by high power capacitor that stores electrical energy. Thus the present invention can be further applied to other equipment that requires high power electricity.

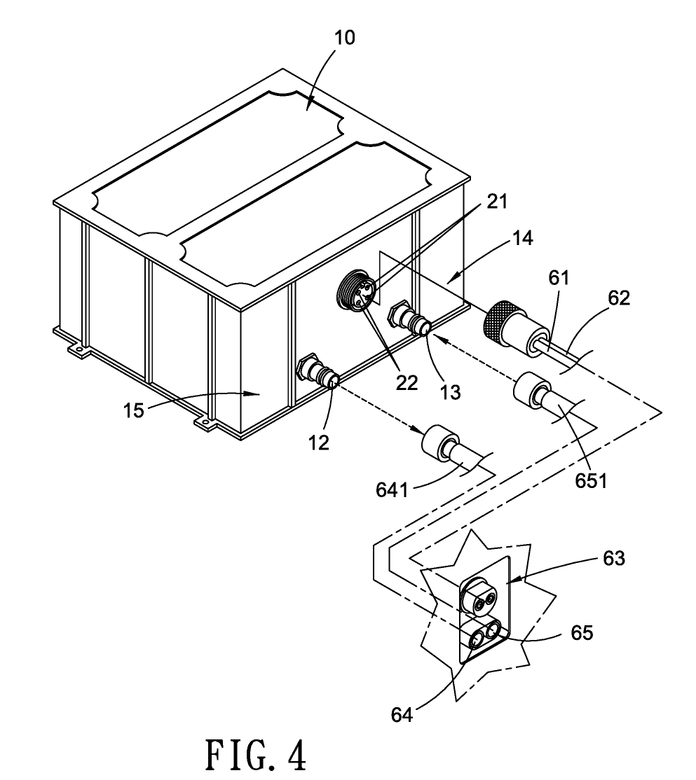

Refer to FIG. 4, a further embodiment is revealed. In this embodiment, the box 10 is a rigid container made from plastic or metals. A first electrical connector interface 14 is disposed on an outer side of the box 10 and is electrically connected to at least one first electrode 21 and at least one second electrode 22. In this embodiment, there are two sets of the first electrode 21 and two sets of the second electrode 22 arranged at the first electrical connector interface 14 and the first electrical connector interface 14 can be used as a charging interface and power output interface simultaneously. A charger 60 is electrically connected to one of the two sets of the first electrode 21 and one of the two sets of the second electrode 22 on the first electrical connector interface 14 by a first cable 61 for charging the cells 30. A power load (such as an electric motor in vehicles) is electrically connected to the other set of the first electrode 21 and the other set of the second electrode 22 on the first electrical connector interface 14 by a second cable 62 for using power from the cells 30.

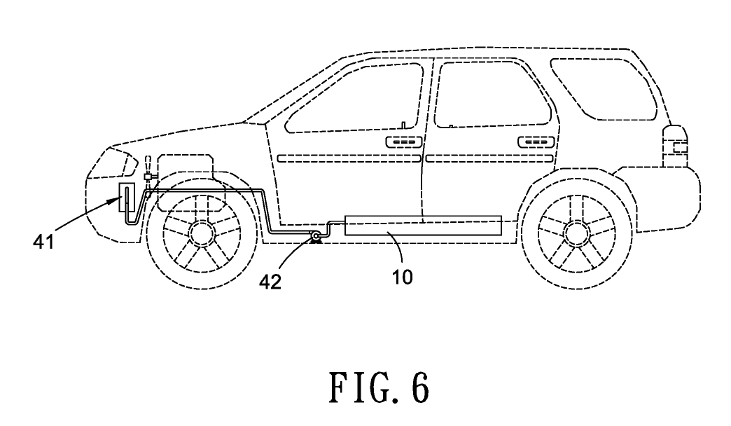

In an embodiment applied to vehicles, the heat exchanger 41 can be disposed on a front side of cars or electric vehicles for reducing temperature of the electrolyte solution 20 by air-cooling or water-cooling solution, as shown in FIG. 6. Then the cooled electrolyte solution 20 is delivered back to the chamber 11 through the inlet 12. Heat generated during charging/discharging of the cells 30 is dissipated by circulation of the electrolyte solution 20 for cooling and temperature control of the cells 30.

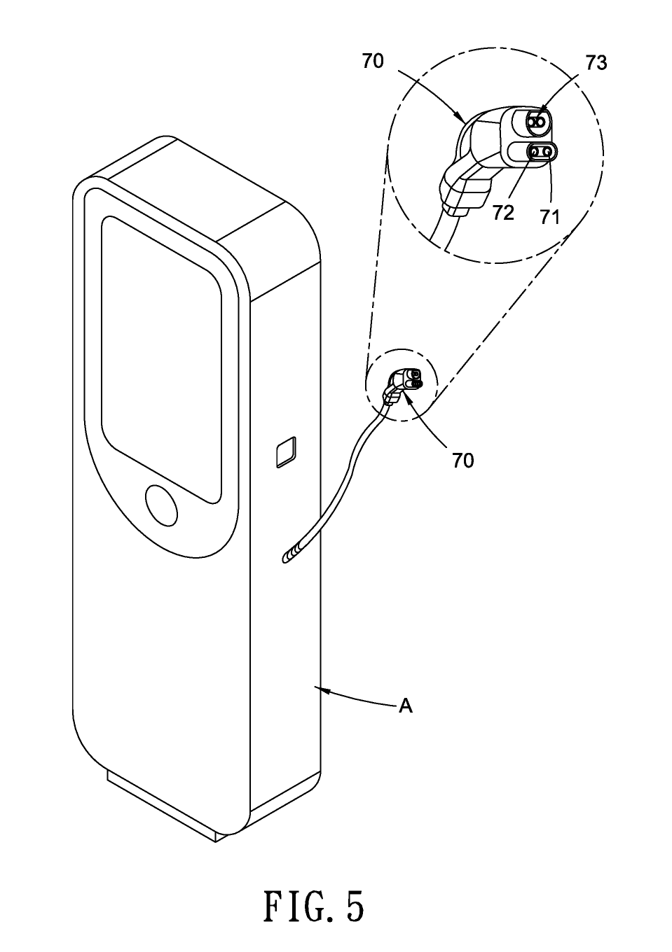

Furthermore, in a further embodiment shown in FIG. 5, the heat exchanging device 40 is disposed on a charging pile A that includes a charging plug 70. The charging plug 70 is arranged with a first fluid connector 71 and a second fluid connector 72 that are connected to the inlet 12 and the outlet 13 of the box 10 respectively. The charging plug 70 is usually connected to the inlet 12 and the outlet 13 of the box 10 through a charging interface 63 located on an outer surface of the electric vehicle, as shown in FIG. 4. A first quick connector 64 able to connect to the first fluid connector 71 and a second quick connector 65 able to connect to the second fluid connector 72 are both set on the charging interface 63. The first quick connector 64 and the second quick connector 65 are connected to the inlet 12 and the outlet 13 by a pipeline 641 and a pipeline 651 respectively. A heat transfer medium inlet and a heat transfer medium inlet outlet on the heat exchanger 41 of the heat exchanging device 40 on the charging pile A are connected to the first fluid connector 71 and the second fluid connector 72 of the charging plug 70 of the charging pile A. The first fluid connector 71 and the second fluid connector 72 are preferably quick connectors. Thereby the cells 30 are cooled by the heat exchanging device 40 on the charging pile A when the vehicle is charged by the charging pile A.

In an embodiment of the present invention, the charger 60 is set on the vehicle and electrically connected to an alternator of the vehicle. Thus the charger 60 can use power generated by the alternator that works as an external power source.

In a further embodiment, the charger 60 is set on the charging pile A and is electrically connected to mains electricity that is used as an external power source. The charging plug 70 further includes a charging terminal 73 that can be electrically connected to the charging interface 63 on the outer surface of the electric vehicle. Thus the cells 30 are charged by the external power source of the charging pile A.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A high power battery/capacitor module comprising:
a box that includes a chamber therein, an inlet communicated with the chamber, and an outlet communicated with the chamber;
electrolyte solution that is filled into the chamber through the inlet of the chamber and is drained from the chamber through the outlet of the chamber;
at least one unpacked cell that is arranged at the chamber of the box, immersed in the electrolyte solution, and having a positive electrode electrically connected to a first electrode set outside the box and a negative electrode electrically connected to a second electrode disposed outside the box; and
a heat exchanging device connected to the inlet and the outlet of the box, working together with the chamber to form a closed fluid circulation space, and used for drawing the electrolyte solution from the chamber through the outlet, reducing temperature of the electrolyte solution, and delivering the cooled electrolyte solution back to the chamber through the inlet circularly.

2. The device as claimed in claim 1, wherein the box is a rigid container or a flexible container.

3. The device as claimed in claim 1, wherein the high power battery/capacitor module further includes an automatic device for balancing concentrations of ions; the automatic device for balancing concentrations of ions includes
a detector used for detecting ion concentration of the electrolyte solution,
a first container for storage of electrolyte solution with high concentration of ions,
a second container in which electrolyte solution with low concentration of ions is stored,
a distributor that is connected to the first container, the second container and the chamber, and used for optionally filling the electrolyte solution with high concentration of ions in the first container, or the electrolyte solution having low concentrations of ions in the second container into the chamber, and
a control circuit electrically connected to the detector and the distributor for control of the distributor to fill the electrolyte solution with high concentration of ions in the first container, or the electrolyte solution having low concentrations of ions in the second container into the chamber according to the ion concentration of the electrolyte solution in the chamber being detected by the detector.

4. The device as claimed in claim 1, wherein the high power battery/capacitor module further includes a charger that is electrically connected to an external power source, the first electrode and the second electrode; the cell is charged by the charger using power from the external power source.

5. The device as claimed in claim 3, wherein the high power battery/capacitor module further includes a charger that is electrically connected to an external power source, the first electrode and the second electrode; the cell is charged by the charger using power from the external power source.

6. The device as claimed in claim 1, wherein the heat exchanging device includes a heat exchanger and a pump that are connected to the inlet and the outlet of the box respectively by pipelines; the pump is used for drawing the electrolyte solution from the chamber through the outlet to be passed through the heat exchanger for temperature reduction and delivering the cooled electrolyte solution back to the chamber through the inlet circularly.

7. The device as claimed in claim 1, wherein the heat exchanging device is disposed on a charging pile that includes a charging plug; a first fluid connector and a second fluid connector are set on the charging plug and are connected to the inlet of the box and the outlet of the box respectively; a heat transfer medium inlet and a heat transfer medium inlet outlet arranged at the heat exchanger of the heat exchanging device are connected to the first fluid connector and the second fluid connector of the charging plug respectively.

8. A high power battery/capacitor module for vehicles and a charger thereof comprising:
a box that includes a chamber therein, an inlet communicated with the chamber, and an outlet communicated with the chamber;
electrolyte solution that is filled in the chamber, introduced into the chamber through the inlet of the chamber and drained from the chamber through the outlet of the chamber;
at least one unpacked cell that is arranged at the chamber of the box, immersed in the electrolyte solution, and having a positive electrode electrically connected to a first electrode set outside the box and a negative electrode electrically connected to a second electrode disposed outside the box;
a heat exchanging device connected to the inlet and the outlet of the box, working together with the chamber to form a closed fluid circulation space, and used for drawing the electrolyte solution from the chamber through the outlet, reducing temperature of the electrolyte solution, and delivering the cooled electrolyte solution back to the chamber through the inlet circularly; and
a charger that is electrically connected to an external power source, the first electrode and the second electrode and using power from the external power source to charge the cell.

9. The device as claimed in claim 8, wherein the box is a rigid container or a flexible container.

10. The device as claimed in claim 8, wherein the heat exchanging device includes a heat exchanger and a pump that are connected to the inlet and the outlet of the box respectively by pipelines; the pump is used for drawing the electrolyte solution from the chamber through the outlet to be passed through the heat exchanger for temperature reduction and delivering the cooled electrolyte solution back to the chamber through the inlet circularly.

11. The device as claimed in claim 8, wherein the heat exchanger is disposed on a front side of the vehicle for reducing temperature of the electrolyte solution by air-cooling or water-cooling; then the cooled electrolyte solution is delivered back to the chamber through the inlet.

12. The device as claimed in claim 8, wherein the heat exchanging device is disposed on a charging pile that includes a charging plug; a first fluid connector and a second fluid connector are set on the charging plug and are connected to the inlet of the box and the outlet of the box respectively; a heat transfer medium inlet and a heat transfer medium inlet outlet arranged at the heat exchanger of the heat exchanging device are connected to the first fluid connector and the second fluid connector of the charging plug respectively.

13. The device as claimed in claim 12, wherein the high power battery/capacitor module for vehicles and the charger thereof further includes an automatic device for balancing concentrations of ions being disposed on the charging pile; the automatic device for balancing concentrations of ions includes
a detector used for detecting ion concentration of the electrolyte solution in the chamber;
a first container for storage of electrolyte solution with high concentration of ions,
a second container in which electrolyte solution with low concentration of ions is stored,
a distributor that is not only connected to the first container and the second container but also connected to the chamber by the first fluid connector and the second fluid connector, and used for optionally filling the electrolyte solution with high concentration of ions in the first container, or the electrolyte solution having low concentrations of ions in the second container into the chamber, and
a control circuit electrically connected to the detector and the distributor for control of the distributor to fill the electrolyte solution with high concentration of ions in the first container, or the electrolyte solution having low concentrations of ions in the second container into the chamber according to the ion concentration of the electrolyte solution in the chamber being detected by the detector.

14. The device as claimed in claim 8, wherein the high power battery/capacitor module further includes an automatic device for balancing concentrations of ions; the automatic device for balancing concentrations of ions includes
a detector used for detecting ion concentration of the electrolyte solution in the chamber,
a first container for storage of electrolyte solution with high concentration of ions,
a second container for storage of electrolyte solution with low concentration of ions,
a distributor that is connected to the first container, the second container and the chamber, and used for optionally filling the electrolyte solution with high concentration of ions in the first container, or the electrolyte solution having low concentrations of ions in the second container into the chamber, and
a control circuit electrically connected to the detector and the distributor for control of the distributor to fill the electrolyte solution with high concentration of ions in the first container, or the electrolyte solution having low concentrations of ions in the second container into the chamber according to the ion concentration of the electrolyte solution in the chamber being detected by the detector.

15. The device as claimed in claim 8, wherein the charger is arranged at the charging pile and is electrically connected to mains electricity; the mains electricity is used as an external power source for the charger.

16. The device as claimed in claim 8, wherein the charger is arranged at the vehicle and is electrically connected to an alternator of the vehicle; the alternator serves as an external power source for the charger.
